(19) United States
(12) Patent Application Publication
(10) Pub. No.: US 2007/0159500 A1
(43) Pub. Date: Jul. 12, 2007

(54) Reinforcement design support apparatus and reinforcement design support program

(75) Inventors: Kenzo Nakano, Tokyo (JP); Ichiro Takahashi, Tokyo (JP)

Correspondence Address: BIRCH STEWART KOLASCH & BIRCH, PO BOX 747, FALLS CHURCH, VA, 22040-0747, US

(73) Assignee: Hitachi Metals Techno, Ltd.

(21) Appl. No.: 11/635,687

(22) Filed: Dec. 8, 2006

(30) Foreign Application Priority Data
Dec. 20, 2005 (JP) 2005-365841

(51) Int. Cl. G09G 5/00

(52) U.S. Cl. 345/666

(57) ABSTRACT

The present invention provides a reinforcement design support apparatus and so on for assisting the selection of a reinforcing metal fixture to be used to reinforce a web opening. The reinforcement design support apparatus comprises an application condition determining unit for determining whether or not a web opening provided in a steel frame beam satisfies an application condition on the basis of steel frame beam data and web opening data read from a design drawing, and when application is impossible, correcting the web opening data and re-determining whether or not the application condition has been satisfied, and a selection unit for selecting a reinforcing metal fixture to be applied to the web opening provided in the steel frame beam when the application condition is determined by the application condition determining means to have been satisfied.

### BACKGROUND OF THE INVENTION

1. Field of the Invention

The present invention relates to Computer Aided Design (CAD), and more particularly to a reinforcement design support apparatus for supporting the reinforcement design of a web opening provided in a steel frame beam.

2. Description of the Related Art

A database CAD system proposed in the related art uses a CAD system on a personal computer. In so doing, quantities can be learned and data can be shared by sorting out character and picture information, while specifications/quantities and data flow from design information to estimate/construction information can be unified (see Japanese Unexamined Patent Application Publication 2003-141191). In this database CAD system, opening information relating to pipes and duct openings provided in beams, floors, and walls is handled, and reinforcement using a fabricator or the like is studied in relation to an opening indicated by the opening information (see paragraph 0064 of Japanese Unexamined Patent Application Publication 2003-141191).

Reinforcement can be studied accurately and quickly using a CAD system such as that described above or in conjunction with such a CAD system. It is therefore conceivable that in the future, computer aided design for assisting the selection of a reinforcing metal fixture used to reinforce a web opening will be required.

### SUMMARY OF THE INVENTION

It is therefore an object of the present invention to provide a reinforcement design support apparatus and a reinforcement design support program for assisting the selection of a reinforcing metal fixture used to reinforce a web opening.

According to the present invention, the object described above is achieved by the following means.

A first invention is a reinforcement design support apparatus comprising: an application condition determining unit for determining whether or not a web opening provided in a steel frame beam satisfies an application condition on the basis of steel frame beam data and web opening data read from a design drawing, and when application is impossible, correcting the web opening data and re-determining whether or not the application condition has been satisfied; and a selection unit for selecting a reinforcing metal fixture to be applied to the web opening provided in the steel frame beam when the application condition is determined by the application condition determining means to have been satisfied.

A second invention is the reinforcement design support apparatus according to the first invention, wherein the selection unit comprises: girder selecting means for selecting a reinforcing metal fixture to be applied to the web opening provided in the steel frame beam on the basis of a hole diameter and a position of the web opening indicated by the web opening data and an ultimate force and a long sustained loading force of the steel frame beam indicated by the steel frame beam data when the steel frame beam indicated by the steel frame beam data is a girder; and binder selecting means for selecting a reinforcing metal fixture to be applied to the web opening provided in the steel frame beam on the basis of the hole diameter and the position of the web opening indicated by the web opening data and the long sustained loading force of the steel frame beam indicated by the steel frame beam data when the steel frame beam indicated by the steel frame beam data is not a girder.

A third invention is the reinforcement design support apparatus according to the second invention, wherein the girder selecting means calculate an ultimate strength application region, which is a region of the steel frame beam in which the web opening indicated by the web opening data can be provided, on the basis of an ultimate strength of the steel frame beam when the hole diameter of the web opening indicated by the web opening data is reinforced by a predetermined reinforcing metal fixture, calculate a long sustained loading strength application region, which is a region of the steel frame beam in which the web opening indicated by the web opening data can be provided, on the basis of a long sustained loading strength of the steel frame beam when the hole diameter of the web opening indicated by the web opening data is reinforced by a predetermined reinforcing metal fixture, select the application region having the greatest distance from a beam end portion, from among the ultimate strength application region and the long sustained loading strength application region, and select a reinforcing metal fixture which includes the position of the web opening indicated by the web opening data in an application range as a reinforcing metal fixture for reinforcing the web opening indicated by the web opening data, and the binder selecting means calculate a long sustained loading strength application region, which is a region of the steel frame beam in which the web opening indicated by the web opening data can be provided, on the basis of the long sustained loading strength of the steel frame beam when the hole diameter of the web opening indicated by the web opening data is reinforced by a predetermined reinforcing metal fixture, and select a reinforcing metal fixture which includes the position of the web opening indicated by the web opening data in the application range as the reinforcing metal fixture for reinforcing the web opening indicated by the web opening data.

A fourth invention is a reinforcement design support program, comprising the steps of: determining whether or not a web opening provided in a steel frame beam satisfies an application condition on the basis of steel frame beam data and web opening data read from a design drawing, and when application is impossible, correcting the web opening data and re-determining whether or not the application condition has been satisfied; and selecting a reinforcing metal fixture to be applied to the web opening provided in the steel frame beam when the application condition is determined to have been satisfied in the application condition determining step.

A fifth invention is the reinforcement design support program according to the fourth invention, wherein the selecting step comprises the steps of: selecting a reinforcing metal fixture to be applied to the web opening provided in the steel frame beam on the basis of a hole diameter and a position of the web opening indicated by the web opening data and an ultimate force and a long sustained loading force of the steel frame beam indicated by the steel frame beam data when the steel frame beam indicated by the steel frame beam data is a girder; and selecting a reinforcing metal fixture to be applied to the web opening provided in the steel frame beam on the basis of the hole diameter and the position of the web opening indicated by the web opening data and the long sustained loading force of the steel frame beam indicated by the steel frame beam data when the steel frame beam indicated by the steel frame beam data is not a girder.

A sixth invention is the reinforcement design support program according to the fifth invention, wherein, in the girder selecting step, an ultimate strength application region, which is a region of the steel frame beam in which the web opening indicated by the web opening data can be provided, is calculated on the basis of an ultimate strength of the steel frame beam when the hole diameter of the web opening indicated by the web opening data is reinforced by a predetermined reinforcing metal fixture, a long sustained loading strength application region, which is a region of the steel frame beam in which the web opening indicated by the web opening data can be provided, is calculated on the basis of a long sustained loading strength of the steel frame beam when the hole diameter of the web opening indicated by the web opening data is reinforced by a predetermined reinforcing metal fixture, the application region having the greatest distance from a beam end portion is selected from among the ultimate strength application region and the long sustained loading strength application region, and a reinforcing metal fixture which includes the position of the web opening indicated by the web opening data in an application range is selected as a reinforcing metal fixture for reinforcing the web opening indicated by the web opening data, and in the binder selecting step, a long sustained loading strength application region, which is a region of the steel frame beam in which the web opening indicated by the web opening data can be provided, is calculated on the basis of the long sustained loading strength of the steel frame beam when the hole diameter of the web opening indicated by the web opening data is reinforced by a predetermined reinforcing metal fixture, and a reinforcing metal fixture which includes the position of the web opening indicated by the web opening data in the application range is selected as the reinforcing metal fixture for reinforcing the web opening indicated by the web opening data.

According to the present invention, a reinforcement design support apparatus and a reinforcement design support program for assisting the selection of a reinforcing metal fixture used to reinforce a web opening can be provided.

### BRIEF DESCRIPTION OF THE DRAWINGS

FIG. 1 is a block diagram showing a reinforcement design support apparatus according to an embodiment of the present invention;

FIG. 2 is a flowchart illustrating processing performed by a metal fixture selection unit 400;

FIG. 3 is a flowchart illustrating in further detail a method used by the metal fixture selection unit 400 to select a reinforcing metal fixture;

FIG. 4 is a flowchart illustrating a method of calculating an application region;

FIG. 5 is a view illustrating a method of calculating a long sustained loading strength application region for a girder;

FIG. 6 is a view illustrating a method of calculating an ultimate strength application region for a girder;

FIG. 7 is a view showing an application region for a girder-reinforcing metal fixture; and

FIG. 8 is a view illustrating a method of calculating a long sustained loading strength application region for a binder.

### DESCRIPTION OF THE PREFERRED EMBODIMENT

A preferred embodiment of the present invention will be described in detail below with reference to the attached drawings.

This embodiment relates to a case in which a shape of a web opening is circle and a shape of a reinforcing metal fixture is ring.

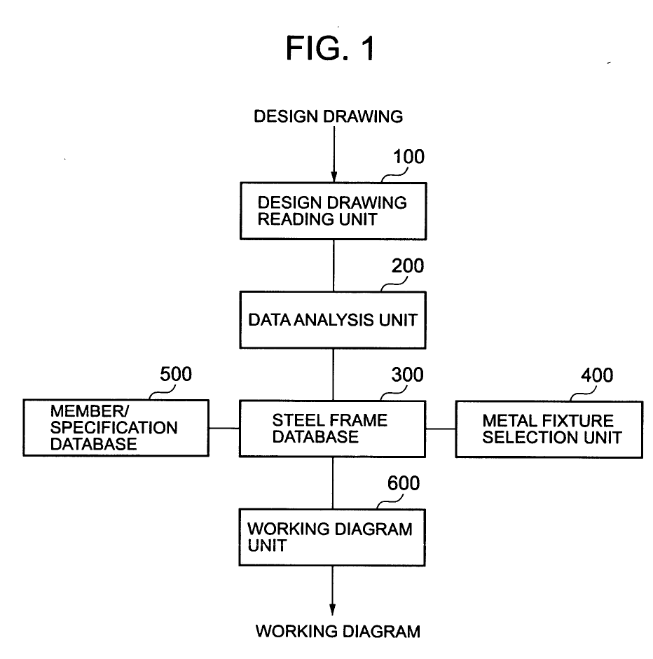

FIG. 1 is a block diagram showing a reinforcement design support apparatus according to an embodiment of the present invention.

As shown in FIG. 1, a reinforcement design support apparatus according to this embodiment of the present invention comprises a design drawing reading unit 100 for reading a design drawing, a data analysis unit 200 for analyzing data read by the design drawing reading unit 100 and extracting steel frame beam data and web opening data therefrom, a steel frame database 300, a metal fixture selection unit 400, a member/specification database 500, and a working diagram unit 600 for creating a working diagram on the basis of data stored in the steel frame database 300.

The reinforcement design support apparatus may be used when creating a working diagram of a reinforcing metal fixture for reinforcing a web opening from a design drawing of at least a steel frame beam and the web opening.

Here, the term “design drawing” refers to paper which designs were drawn on or electronic data showing at least a steel frame beam and a web opening, as noted above. The design drawing reading unit 100 may be any device that functions as an interface between the reinforcement design support apparatus according to this embodiment and the design drawing, for example a scanner which reads data depicted on paper which designs were drawn on as a design drawing, a program which converts electronic data serving as the design drawing into a desired data format (a tabular format or the like), and so on.

The data analysis unit 200 analyzes data output by the design drawing reading unit 100 and extracts steel frame beam data and web opening data therefrom. Here, the term “steel frame beam data” denotes data indicating the material, size, and so on of a steel frame beam, while the term “web opening data” denotes data indicating the hole diameter, position (distance from beam end to hole center), eccentricity, and so on of a web opening.

The steel frame database 300 stores the beam data and web opening data output from the data analysis unit, and also stores data (reinforcing metal fixture data) relating to a reinforcing metal fixture for reinforcing the web opening indicated by the web opening data. The reinforcing metal fixture for reinforcing the web opening indicated by the web opening data is selected by the metal fixture selection unit 400. The reinforcing metal fixture data indicating the selected reinforcing metal fixture are output to the steel frame database 300 from the metal fixture selection unit 400.

The member/specification database 500 outputs electronic image data relating to the steel frame beam, web opening, and reinforcing metal fixture indicated respectively by the web opening data, steel frame beam data, and reinforcing metal fixture data, which are stored in the steel frame database 300, to the steel frame database 300.

The working diagram unit 600 creates a working diagram using the steel frame beam data, web opening data, and reinforcing metal fixture data, which are stored in the steel frame database 300, together with electronic image data relating to the steel frame beam indicated by the steel frame beam data, electronic image data relating to the web opening indicated by the web opening data, and electronic image data relating to the reinforcing metal fixture indicated by the reinforcing metal fixture data.

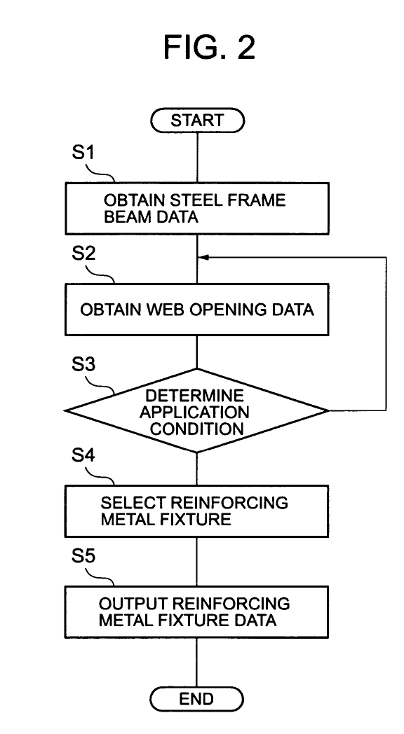

FIG. 2 is a flowchart illustrating processing performed by the metal fixture selection unit 400.

As shown in FIG. 2, first, the metal fixture selection unit 400 obtains the steel frame beam data from the steel frame database 300 (S1).

Next, the metal fixture selection unit 400 obtains the web opening data from the steel frame database 300 (S2).

Next, the metal fixture selection unit 400 determines whether or not the web opening provided in the steel frame beam satisfies an application condition on the basis of the obtained steel frame beam data and web opening data (S3). Here, the application condition is a condition for determining whether or not the steel frame beam indicated by the steel frame beam data is a steel frame beam to which a reinforcing metal fixture can be applied, and when a certain steel frame beam does not satisfy the condition, a reinforcing metal fixture cannot be applied to that steel frame beam. For example, when the hole diameter of the web opening is large, the reinforcing metal fixture applied to the web opening must also be large, and therefore the reinforcing metal fixture may interfere with a reinforcing metal fixture to be applied to another web opening or protrude from the steel frame beam. Accordingly, the likelihood of the steel frame beam not satisfying the application condition such that a reinforcing metal fixture cannot be applied to the steel frame beam may increase. However, according to this embodiment, the application condition is studied before selecting a reinforcing metal fixture, and therefore the selected reinforcing metal fixture can always be applied to the web opening. Hence, situations in which it is determined upon completion of the reinforcement design that a reinforcing metal fixture cannot be applied to a web opening such that the reinforcement design must be restarted can be eliminated. As a result, delays and restarts in the web opening reinforcement work can be prevented, and by extension, delays in the overall construction work can also be prevented.

When it is determined that application is impossible, the metal fixture selection unit 400 corrects the web opening data in the steel frame database, obtains new web opening data from the steel frame database, and determines anew whether or not the application condition is satisfied. Thus, the hole diameter of the web opening can be designed flexibly.

When it is determined that the application condition has been satisfied, the metal fixture selection unit 400 selects a reinforcing metal fixture to be applied to the web opening provided in the steel frame beam (S4).

The metal fixture selection unit 400 then outputs reinforcing metal fixture data indicating the selected reinforcing metal fixture to the steel frame database (S5)

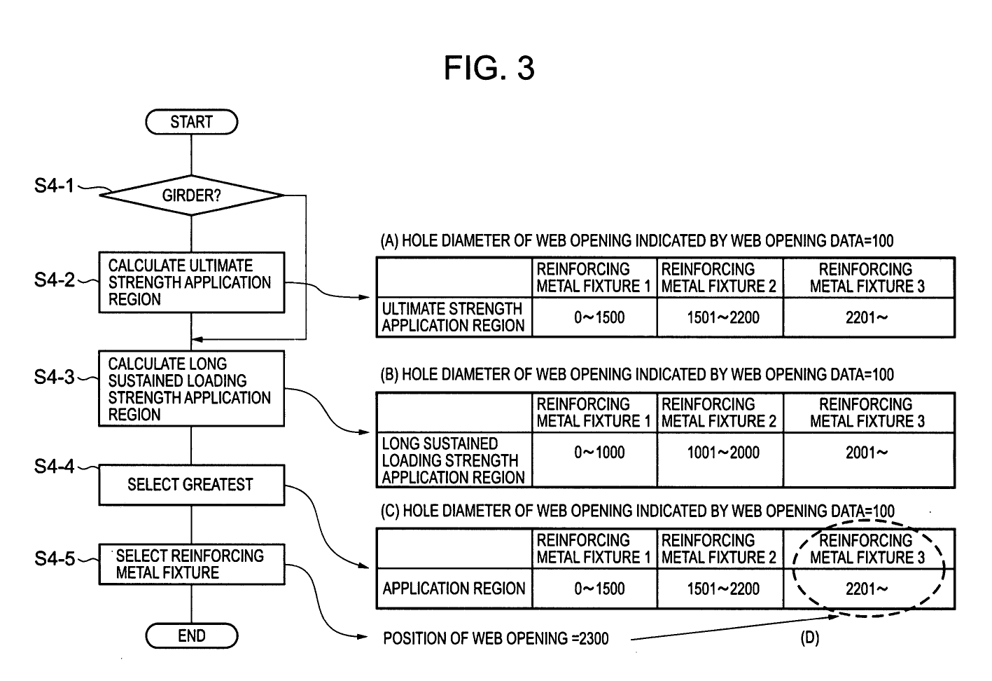

FIG. 3 is a flowchart illustrating in further detail the method used by the metal fixture selection unit 400 to select a reinforcing metal fixture.

As described above, the metal fixture selection unit 400 selects a reinforcing metal fixture to be applied to the web opening provided in the steel frame beam when the application condition is determined to have been satisfied.

First, the metal fixture selection unit 400 determines whether or not the steel frame beam indicated by the steel frame beam data is a girder (S4-1). When the steel frame beam is a girder, the metal fixture selection unit 400 selects a reinforcing metal fixture to be applied to the web opening provided in the steel frame beam on the basis of the hole diameter and position of the web opening indicated by the web opening data, and the ultimate force and long sustained loading force of the steel frame beam indicated by the steel frame beam data. More specifically, for example, assuming that the hole diameter of the web opening indicated by the web opening data is φ=100 mm, the metal fixture selection unit 400 first calculates an ultimate strength application region, which is a region of the steel frame beam in which the web opening indicated by the web opening data can be provided, on the basis of the ultimate strength of the steel frame beam when the hole diameter φ=100 mm of the web opening indicated by the web opening data is reinforced by a predetermined reinforcing metal fixture (S4-2, FIG. 3A). Next, the metal fixture selection unit 400 calculates a long sustained loading strength application region, which is a region of the steel frame beam in which the web opening indicated by the web opening data can be provided, on the basis of the long sustained loading strength of the steel frame beam when the hole diameter φ=100 mm of the web opening indicated by the web opening data is reinforced by a predetermined reinforcing metal fixture (S4-3, FIG. 3B). Next, the metal fixture selection unit 400 selects the region having the greatest distance from a beam end portion, from among the ultimate strength application region and the long sustained loading strength application region, as the application region (S4-4, FIG. 3C). The metal fixture selection unit 400 then selects a reinforcing metal fixture which includes the position of the web opening indicated by the web opening data within its application range as the reinforcing metal fixture for reinforcing the web opening indicated by the web opening data (S4-5, FIG. 3D).

On the other hand, when the steel frame beam indicated by the steel frame beam data is not a girder, the metal fixture selection unit 400 selects a reinforcing metal fixture to be applied to the web opening provided in the steel frame beam on the basis of the hole diameter and position of the web opening indicated by the web opening data and the long sustained loading force of the steel frame beam indicated by the steel frame beam data. More specifically, for example, assuming that the hole diameter of the web opening indicated by the web opening data is φ=100 mm, the metal fixture selection unit 400 first calculates a long sustained loading strength application region, which is a region of the steel frame beam in which the web opening indicated by the web opening data can be provided, on the basis of the long sustained loading strength of the steel frame beam when the hole diameter φ=100 mm of the web opening indicated by the web opening data is reinforced by a predetermined reinforcing metal fixture (S4-3, FIG. 3B). The metal fixture selection unit 400 then selects a reinforcing metal fixture which includes the position of the web opening indicated by the web opening data within its application range as the reinforcing metal fixture for reinforcing the web opening indicated by the web opening data (S4-5, FIG. 3D). Note that in this case, the step S4-4 is bypassed.

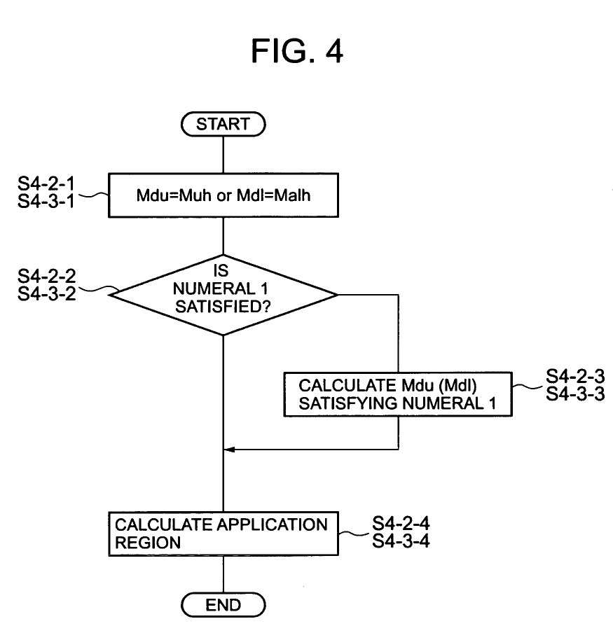

FIG. 4 is a flowchart showing a method of calculating the application region.

As shown in FIG. 4, a determination is made as to whether or not the following equation is satisfied assuming that M_{du}=Mᵤₕ in the case of the ultimate strength application region, and assuming that M_{dl}=Mₐₗₕ in the case of the long sustained loading force application region (S4-2-1, S4-3-1).

[Numeral 1]

Long sustained loading
M_{dLh}/M_{aLh}+Q_{dLh}/Q_{aLh}{(M_{aLh}−M_{aLhf})/M_{aLh}}≦1.0 and Q_{dLh}≦Q_{aLh}

Ultimate
M_{du}/Mᵤₕ+Q_{du}/Qᵤₕ{(Mᵤₕ−M_{uhf})/M_{Uh}}≦1.0 and Q_{du}≦Qᵤₕ

When Numeral 1 is satisfied, the application region is calculated in accordance with Numeral 2 (S4-2-4, S4-3-4).

[Numeral 2]

Long sustained loading
M_{dLh}=wL₀²/12−wL₀Lₕ/2 A ZONE
M_{dLh}=wL₀²/24 B ZONE
M_{dLh}=wL₀²/12−wL₀(L₀−Lₕ)/2 C ZONE

Ultimate
M_{duh}=Q_{du}(L₀/2−Lₕ)

When Numeral 1 is not satisfied, M_{duh} and Q_{du} or M_{dLh} and Q_{dLh} are calculated to satisfy Numeral 1 (S4-2-3, S4-3-3), and the application region is calculated from the calculated M_{duh} or M_{dLh} on the basis of Numeral 2 (S4-2-4, S4-3-4).

Here,

L₀: span inside measurement
Lₕ: distance from beam end to center of opening

(Long Sustained Loading-related Symbols)
M_{aLe}: allowable flexural strength for long sustained loading of unperforated beam in pure bending
M_{aLef}: allowable flexural strength for long sustained loading of unperforated beam that can be supported with Q_{aLe}
Q_{aLe}: allowable shearing strength for long sustained loading of unperforated beam in pure shearing
M_{aLh}: allowable flexural strength for long sustained loading of beam at opening portion in pure bending
M_{aLhf}: allowable flexural strength for long sustained loading of beam at opening portion that can be supported with Q_{aLh}
Q_{aLh}: allowable shearing strength for long sustained loading of beam at opening portion in pure shearing
M_{dLh}: bending moment for long sustained loading at opening portion
Q_{dLh}: shearing force for long sustained loading at opening portion
w: uniformly distributed load

(Ultimate-related Symbols)
Mᵤₑ: ultimate flexural strength of unperforated beam in pure bending
M_{uef}: ultimate flexural strength of unperforated beam that can be supported with Qᵤₑ
Qᵤₑ: ultimate shearing strength of unperforated beam in pure shearing
Mᵤₕ: ultimate flexural strength of beam at opening portion in pure bending
M_{uhf}: ultimate flexural strength of beam at opening portion that can be supported with Qᵤₕ
Qᵤₕ: ultimate shearing strength of beam at opening portion in pure shearing
M_{due}: ultimate bending moment of beam end portion
M_{duh}: ultimate bending moment of beam at opening portion
Q_{du}: ultimate shearing force of beam in span
Q_{duh}: ultimate shearing force of beam at opening portion

The method of selecting a reinforcing metal fixture will be described below in further detail.

[Girder]

In the case of a girder, the reinforcing metal fixture is selected by assuming the long sustained loading and ultimate force distribution from the cross-section and material of the girder and the span of the beam in accordance with the design conditions described below, calculating the strength of the web opening portion of the beam when reinforced by each reinforcing metal fixture, determining the application region of each reinforcing metal fixture, and determining the reinforcing metal fixture application region in which the web opening position exists.

(Long Sustained Loading)

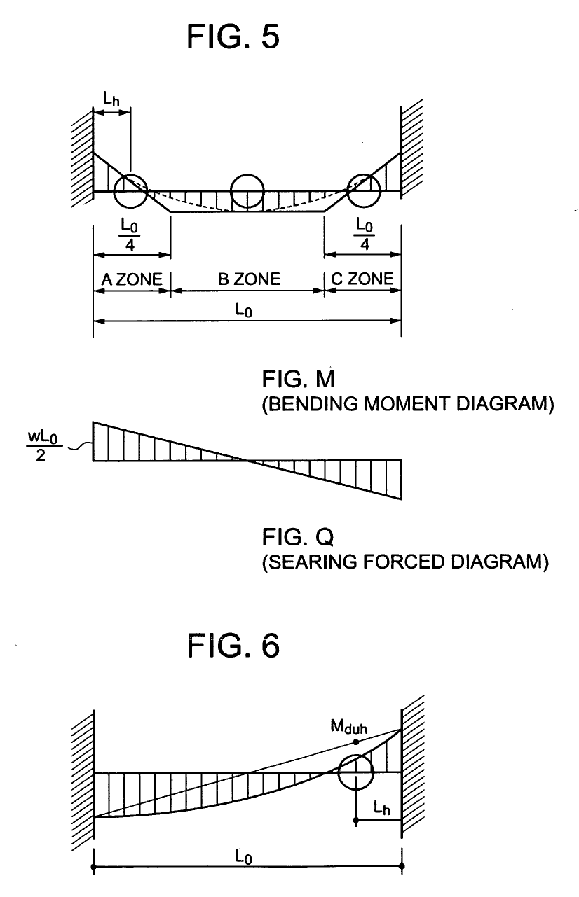

The long sustained loading will be described with reference to FIG. 5.

A condition of the long sustained loading is that force occurring in the web opening portion be smaller than the strength at the web opening portion of the beam reinforced by the reinforcing metal fixture. This is confirmed by satisfying the following equation.

[Numeral 3]
M_{dLh}/M_{aLh}+Q_{dLh}/Q_{aLh}{(M_{aLh}−M_{aLhf})/M_{aLh}}≦1.0 and Q_{dLh}<Q_{aLh} (1)

Force occurring in the girder over the long sustained loading is determined by calculating a uniformly distributed load w at which deflection and force are minimized under the following condition, and calculating the bending moment (M_{dlh}) and shearing force (Q_{dLh}) for each of the A zone to the C zone, assuming a force condition of the beam in which the uniformly distributed load w acts.

[Numeral 4]

(Uniformly Distributed Load w)

The uniformly distributed load w is determined in according with Equation (a) using the smallest of the following values (1) to (3).
(1) w when deflection δ_{c} at the central portion of beam reaches 25 mm
(2) w when deflection δ_{c} at the central portion of beam reaches L₀/300
(3) w when unperforated beam reaches the long sustained loading allowable strength
   w=min(384EI×25/L₀⁴, 384EI(L₀/300)/L₀⁴, M_{aLe}/{L₀²/12+L₀(M_{aLe}−M_{aLef})/2Q_{aLe},}2Q_{aLe}/L₀) (a)

(Force Occurring in Girder)

A ZONE
M_{dLh}=wL₀²/12−wL₀Lₕ/2 (2)

B ZONE
M_{dLh}=wL₀²/24 (3)

C ZONE
M_{dLh}=wL₀²/12−wL₀(L₀−Lₕ)/2 (4)
Q_{dLh}=wL₀/2−wLₕ (5)

The distance Lₕ from the beam end portion at which the flexural strength M_{aLh} at the web opening portion of the beam reinforced by the reinforcing metal fixture and the bending moment M_{dLh} in an arbitrary position of the beam take identical values is calculated using Equation (2) and Equation (4). A range in which the distance from the two end portions of the beam equals or exceeds the distance Lₕ calculated for each reinforcing metal fixture serves as the application region of each reinforcing metal fixture.

(Long Sustained Loading Related Symbols)
M_{aLe}: allowable flexural strength for long sustained loading of unperforated beam in pure bending
M_{aLef}: allowable strength for long sustained loading of unperforated beam that can be supported with Q_{aLe}
Q_{aLe}: allowable shearing strength for long sustained loading of unperforated beam in pure shearing
M_{aLh}: allowable flexural strength for long sustained loading of beam at opening portion in pure bending
M_{aLhf}: allowable flexural strength for long sustained loading of beam at opening portion that can be supported with Q_{aLh}
Q_{aLh}: allowable shearing strength for long sustained loading of beam at opening portion in pure shearing
M_{dLh}: bending moment for long sustained loading of beam at opening portion
Q_{dLh}: shearing force for long sustained loading of beam at opening portion

(Ultimate)

The ultimate will now be described with reference to FIG. 6.

A condition of the ultimate is that force occurring in the web opening portion be smaller than the strength at the web opening portion of the beam reinforced by the reinforcing metal fixture. This is confirmed by satisfying the following equation.

[Numeral 5]
M_{du}/Mᵤₕ+Q_{du}/Qᵤₕ{(M_{Uh}−M_{uhf})/Mᵤₕ}≦1.0 and Q_{du}≦Qᵤₕ (6)

In the case of the ultimate, the force (M_{duh}, W_{duh}) occurring in the beam when a beam having the span inside measurement L₀ reaches a plastic state taking shear into account at both ends is determined as follows.

[Numeral 6]

Ultimate force
Q_{duh}=Q_{dLh}+Q_{du} (7)
Q_{du}=min(Mᵤₑ/{(Mᵤₑ−M_{uef})/Qᵤₑ+L₀/2}, Qᵤₑ) (8)
M_{duh}=Q_{du}(L₀/2−Lₕ) (9)

The distance Lₕ from the beam end portion at which the ultimate strength Mᵤₕ at the web opening portion of the beam reinforced by the reinforcing metal fixture takes an identical value to the bending moment M_{duh} in an arbitrary position of the beam is calculated using Equation (9). A range in which the distance from the two end portions of the beam equals or exceeds Lₕ calculated for each reinforcing metal fixture serves as the application region of each reinforcing metal fixture.

(Ultimate-related Symbols)
Mᵤₑ: ultimate flexural strength of unperforated beam in pure bending
M_{uef}: ultimate flexural strength of unperforated beam that can be supported with Qᵤₑ
Qᵤₑ: ultimate shearing strength of unperforated beam in pure shearing
Mᵤₕ: ultimate flexural strength of beam at opening portion in pure bending
M_{uhf}: ultimate flexural strength of beam at opening portion that can be supported with Qᵤₕ
Qᵤₕ: ultimate shearing strength of beam at opening portion in pure shearing
M_{pf}: plastic moment of flange alone
M_{pw}: plastic moment of web alone at unperforated portion
M_{pw′}: plastic moment of web alone at opening portion
Mₚₛ: plastic moment of reinforcing metal fixture
Q_{y}: yield shearing strength of web at unperforated portion
γₕ₁: reduction coefficient for plastic moment of flange alone, determined in accordance with combination of beam and reinforcing metal fixture
γₕ₂: correction coefficient for yield shearing strength of web, determined in accordance with combination of beam and reinforcing metal fixture
γₕ₃: reduction coefficient for yield shearing strength of web, determined in accordance with combination of beam and reinforcing metal fixture
M_{due}: ultimate bending moment of beam end portion
M_{duh}: ultimate bending moment of beam at opening portion
Q_{du}: ultimate shearing force of beam in span
Q_{duh}: ultimate shearing force of beam at opening portion
L₀: span inside measurement
Lₕ: distance from beam end to center of opening

(Reinforcing Metal Fixture Selection)

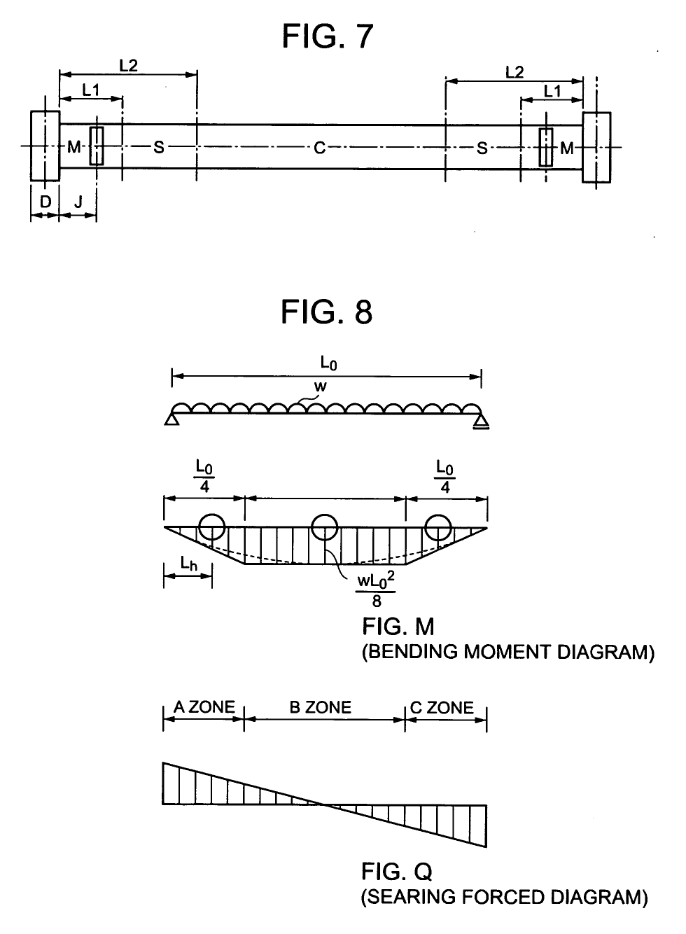

FIG. 7 is a view showing an application region of a reinforcing metal fixture for a girder.

As regards reinforcing metal fixture selection, of the application regions for each reinforcing metal fixture calculated for the long sustained loading and the ultimate, those having the greatest distance from the beam end portion to the application region are set as application regions. Here, the application regions are indicated by M, S, C. Further, selecting the application region having the greatest distance from the beam end portion from among the ultimate strength application and the long sustained loading strength application region means selecting the application region having a greater distance L1 from the beam end portion, from among the ultimate strength application region M calculated on the basis of the ultimate strength and the long sustained loading strength application region M calculated on the basis of the long sustained loading strength, as the final application region M, for example (see FIG. 3).

Next, by determining the reinforcing metal fixture application region in which the web opening position exists, the reinforcing metal fixture is selected.

[Binder]

The case of a binder will now be described with reference to FIG. 8.

A condition of the binder is that the force occurring in the web opening portion be smaller than the strength at the web opening portion of the beam reinforced by the reinforcing metal fixture. This is confirmed by satisfying the following equation.

[Numeral 7]
M_{dLh}/M_{aLh}+Q_{dLh}/Q_{aLh}{(M_{aLh}−M_{aLhf})/M_{aLh}}≦1.0 and Q_{dLh}≦Q_{aLh} (10)

Force occurring in the binder is determined by calculating a uniformly distributed load w at which deflection and force are minimized under the following condition, and calculating the bending moment (M_{dlh}) and shearing force (Q_{dlh}) for each of the A zone to the C zone assuming a force condition in which the uniformly distributed load w acts.

[Numeral 8]

(Uniformly Distributed Load w)

The uniformly distributed load w is determined in according with Equation (b) using the smallest of the following values (1) to (3).
(1) w when deflection δ_{c} at the central portion of beam reaches 25 mm
(2) w when deflection δ_{c} at the central portion of beam reaches L₀/300
(3) w when unperforated beam reaches the long sustained loading allowable strength
   w=min (384EI×25/5L₀⁴, 384EI(L₀/300)/5L₀⁴, M_{aLe}/{L₀²/8+L₀(M_{aLe}−M_{aLef})/2Q_{aLe}}, 2Q_{aLe}/L₀) (b)

(Force Occurring in Binder)

A ZONE
M_{dLh}=wL₀Lₕ/2 (11)

B ZONE
M_{dLh}=wL₀²/8 (12)

C ZONE
M_{dLh}=wL₀(L₀−Lₕ)/2 (13)
Q_{dLh}=wL₀/2−wLₕ (14)

The distance Lₕ from the beam end portion at which the flexural strength Mₐₗₕ at the web opening portion of the beam reinforced by the reinforcing metal fixture and the bending moment M_{dlh} in an arbitrary position of the beam take identical values is calculated using Equation (11) and Equation (13). A range in which the distance from the two end portions of the beam equals or exceeds Lₕ calculated for each type of reinforcing metal fixture serves as the application region of the reinforcing metal fixture.

(Binder-related Symbols)
M_{aLe}: allowable flexural strength for long sustained loading of unperforated beam in pure bending
M_{aLef}: allowable flexural strength for long sustained loading of unperforated beam that can be supported with Qᵤₑ
Q_{aLe}: allowable shearing strength for long sustained loading of unperforated beam in pure shearing
M_{aLh}: allowable flexural strength for long sustained loading of beam at opening portion in pure bending
M_{aLhf}: allowable flexural strength for long sustained loading of beam at opening portion that can be supported with Qᵤₕ
Q_{aLh}: allowable shearing strength for long sustained loading of beam at opening portion in pure shearing
L₀: span inside measurement
Lₕ: distance from beam end to center of opening

As described above, this embodiment is used to support the reinforcement design of a web opening in a beam, but the embodiment may also be used for design support at the design stage.

Further, in the metal fixture selection flow, binder selection means are employed when the beam is not a girder, but selection means for selecting a cantilever beam or the like may also be provided.

What is claimed is:

1. A reinforcement design support apparatus comprising:
an application condition determining unit for determining whether or not a web opening provided in a steel frame beam satisfies an application condition on the basis of steel frame beam data and web opening data read from a design drawing, and when application is impossible, correcting said web opening data and re-determining whether or not said application condition has been satisfied; and
a selection unit for selecting a reinforcing metal fixture to be applied to said web opening provided in said steel frame beam when said application condition is determined by said application condition determining means to have been satisfied.

2. The reinforcement design support apparatus according to claim 1, wherein said selection unit comprises:
girder selecting means for selecting a reinforcing metal fixture to be applied to said web opening provided in said steel frame beam on the basis of a hole diameter and a position of said web opening indicated by said web opening data and an ultimate force and a long sustained loading force of said steel frame beam indicated by said steel frame beam data when said steel frame beam indicated by said steel frame beam data is a girder; and
binder selecting means for selecting a reinforcing metal fixture to be applied to said web opening provided in said steel frame beam on the basis of said hole diameter and said position of said web opening indicated by said web opening data and said long sustained loading force of said steel frame beam indicated by said steel frame beam data when said steel frame beam indicated by said steel frame beam data is not a girder.

3. The reinforcement design support apparatus according to claim 2, wherein said girder selecting means calculate an ultimate strength application region, which is a region of said steel frame beam in which said web opening indicated by said web opening data can be provided, on the basis of an ultimate strength of said steel frame beam when said hole diameter of said web opening indicated by said web opening data is reinforced by a predetermined reinforcing metal fixture,
calculate a long sustained loading strength application region, which is a region of said steel frame beam in which said web opening indicated by said web opening data can be provided, on the basis of a long sustained loading strength of said steel frame beam when said hole diameter of said web opening indicated by said web opening data is reinforced by a predetermined reinforcing metal fixture,
select the application region having the greatest distance from a beam end portion, from among said ultimate strength application region and said long sustained loading strength application region, and
select a reinforcing metal fixture which includes said position of said web opening indicated by said web opening data within its application range as a reinforcing metal fixture for reinforcing said web opening indicated by said web opening data, and
said binder selecting means calculate a long sustained loading strength application region, which is a region of said steel frame beam in which said web opening indicated by said web opening data can be provided, on the basis of said long sustained loading strength of said steel frame beam when said hole diameter of said web opening indicated by said web opening data is reinforced by a predetermined reinforcing metal fixture, and
select a reinforcing metal fixture which includes said position of said web opening indicated by said web opening data within its application range as said reinforcing metal fixture for reinforcing said web opening indicated by said web opening data.

4. A reinforcement design support program, comprising the steps of:
determining whether or not a web opening provided in a steel frame beam satisfies an application condition on the basis of steel frame beam data and web opening data read from a design drawing, and when application is impossible, correcting said web opening data and re-determining whether or not said application condition has been satisfied; and
selecting a reinforcing metal fixture to be applied to said web opening provided in said steel frame beam when said application condition is determined to have been satisfied in said application condition determining step.

5. The reinforcement design support program according to claim 4, wherein said selecting step comprises the steps of:
selecting a reinforcing metal fixture to be applied to said web opening provided in said steel frame beam on the basis of a hole diameter and a position of said web opening indicated by said web opening data and an ultimate force and a long sustained loading force of said steel frame beam indicated by said steel frame beam data when said steel frame beam indicated by said steel frame beam data is a girder; and
selecting a reinforcing metal fixture to be applied to said web opening provided in said steel frame beam on the basis of said hole diameter and said position of said web opening indicated by said web opening data and said long sustained loading force of said steel frame beam indicated by said steel frame beam data when said steel frame beam indicated by said steel frame beam data is not a girder.

6. The reinforcement design support program according to claim 5, wherein, in said girder selecting step, an ultimate strength application region, which is a region of said steel frame beam in which said web opening indicated by said web opening data can be provided, is calculated on the basis of an ultimate strength of said steel frame beam when said hole diameter of said web opening indicated by said web opening data is reinforced by a predetermined reinforcing metal fixture,
a long sustained loading strength application region, which is a region of said steel frame beam in which said web opening indicated by said web opening data can be provided, is calculated on the basis of a long sustained loading strength of said steel frame beam when said hole diameter of said web opening indicated by said web opening data is reinforced by a predetermined reinforcing metal fixture,
the application region having the greatest distance from a beam end portion is selected from among said ultimate strength application region and said long sustained loading strength application region, and
a reinforcing metal fixture which includes said position of said web opening indicated by said web opening data within its application range is selected as a reinforcing metal fixture for reinforcing said web opening indicated by said web opening data, and
in said binder selecting step, a long sustained loading strength application region, which is a region of said steel frame beam in which said web opening indicated by said web opening data can be provided, is calculated on the basis of said long sustained loading strength of said steel frame beam when said hole diameter of said web opening indicated by said web opening data is reinforced by a predetermined reinforcing metal fixture, and
a reinforcing metal fixture which includes said position of said web opening indicated by said web opening data within its application range is selected as said reinforcing metal fixture for reinforcing said web opening indicated by said web opening data.
